(19) United States
(12) Patent Application Publication
(10) Pub. No.: US 2011/0317122 A1
(43) Pub. Date: Dec. 29, 2011

(54) Eyewear with stabilization nosepiece

(75) Inventor: Michelle Renee' Havens-Olmstead, Spokane, WA (US)

(73) Assignee: Michelle Renee Havens-Olmstead, Spokane, WA (US)

(21) Appl. No.: 12/803,303

(22) Filed: Jun. 24, 2010

(51) Int. Cl. G02C 5/12

(52) U.S. Cl. 351/136

(57) ABSTRACT

The present invention relates to a nose-brow platform that replaces the standard nose pads of glasses, especially safety glasses, this platform stabilizes and prevents movement of the glasses toward the face, especially when the user is in the inclined position looking up. This platform maintains space between the forehead and lens of the glasses preventing contact with the eyes and eyelashes, also allowing air to flow freely and thus preventing fogging of the lens. The stabilization nose-brow platform supports a nitrous oxide nose while providing the comfort of an even distribution of the weight of the nose and hoses. Such features provide greater comfort for patients during dental or medical treatment or sports and the like.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC. APPENDIX

Not Applicable

### BACKGROUND OF THE INVENTION

### Field of the Invention

This invention related to eyewear with an enhanced fit due to a stabilization platform that replaces the nose pads on standard eyewear, especially eyewear used for safety and or activities such as sports.

Standard safety glasses consist of one or more lens attached to two ear pieces that constitutes the frame, in the center a standard upside down “U” shaped nose pad seats the glasses level on the face when the user is in an upright alert position, the nose pad does not support the glasses during movement, especially when looking up.

Standard safety glasses consist of a single unit nose rest that supports the glasses on the bridge of the nose, the upper frame has no support on the forehead or brow area, when a user is laying down or in an inclined position, therefore the frame and lens push into the users eyes.

Eyewear for safety applications in industrial, medical and /or sports are used to protect a user's eyes. Such eyewear is usually designed to fit relatively closely to a user's face, so that noxious gas, liquid, particles, contaminants, and the like, do not touch or affect a user's eye(s), this often causes fogging of the lens.

Standard eyewear or safety glasses that move and tip into the forehead cause pressure on the eyelashes, creating a visual problems as well as a comfort issue, if the user is wearing makeup, especially mascara, this will cause smearing onto the lens and the user's face.

Safety and some sports glasses or eyewear are often designed and formed such that they are bulky and heavy to wear, some are tight-fitting and uncomfortable as well.

Such eyewear is often provided in only a few sizes which do not fit every user's face.

Further, poor-fitting eyewear will result in movement of the user to adjust glasses and thus movement of the glasses may not adequately cover and/or protect a user's eyes.

In the medical use of safety glasses, especially dental surgery the user is in the inclined position looking up, standard glasses move around, tip into the eyes and this make the patients uncomfortable.

During dental procedures when using nitrous oxide a large nose cone is used that seals around a users nose, this prevents the standard safety glasses nose rest to fit on the users nose, causing the safety glasses to sit on top of the nose resulting in the lens not covering or protecting the eyes.

### BRIEF SUMMARY OF THE INVENTION

The present invention relates to a nose-brow platform designed to replace the nose pads for eyewear, especially safety glasses, this platform stabilizes and prevents movement of the eyewear.

The term “nose-brow platform” or “stabilization nose piece” used in this description indicates an “X” shaped support piece that is made of soft moldable plastic or other material, fixed to a pair of glasses, especially safety glasses, intended to support the glasses on the face preventing movement in any direction, especially when the user is in the horizontal or inclined position looking up or in various vertical viewing angles.

The present invention's nose-brow platform maintains a space between the lens and eyes and eyelashes, by resting between the brows of the users face, thus improving comfort.

The present invention's nose-brow platform allows air to flow freely beneath the frame and lens, and therefore prevents fogging of the lens, this provides better vision.

The nose-brow platform is designed to function with the two ear pieces that creates a tripod of support for the glasses on the ears and nose-brow area, this support distributes the weight of the glasses evenly over the users face, making the glasses feel lightweight.

The present invention's nose-brow platform provides a stabilized base to support and distribute the weight of the glasses, nitrous oxide nose and hose weight during dental surgery when in the inclined position.

The present invention solves the problems of eyewear, especially safety glasses, from moving on patients during medical or dental procedures, when the position of the users is in the inclined position and looking up.

The present invention solves the problems of safety glasses tipping into the face, fogging the lens during medical or dental procedures, patients are usually nervous and sweating, the fogging creates a panic when the vision is impaired.

The nose-brow platform centers the glasses on the users face, this creates a custom feel for a variety of face sizes and shapes, children and well as adults are able to use one size of glasses.

### BRIEF DESCRIPTION OF THE SEVERAL VIEWS OF THE DRAWING

FIG. 1 drawing shows a perspective view of the underside of the nose-brow platform;

FIG. 1A drawing shows a side view of the nose-brow platform;

FIG. 1B drawing shows a perspective view from the bottom of the nose-brow platform;

FIG. 2 photograph shows the replacement of the standard nose pads with the nose-brown platform.

### DETAILED DESCRIPTION OF THE INVENTION

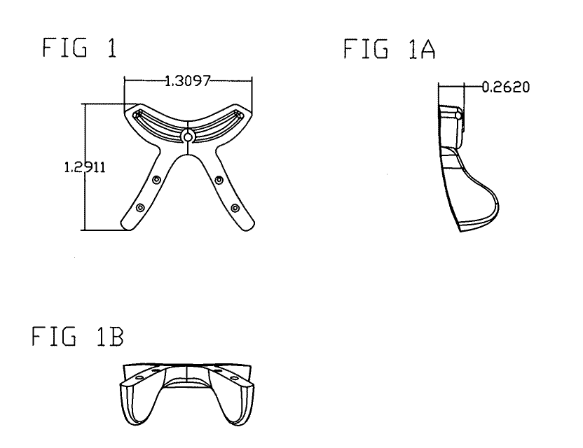

With reference to FIG. 1, the nose-brow platform with the unique “X” shaped platform rests on the forehead in the brow area and extends down the nose, this portion attaches or is fixed to a standard pair of eyewear, especially safety glasses, the position of nose-brow platform works with the ear pieces to establish a tripod (three areas) of support for the glasses creating increased stability compared to standard glasses.

With reference to FIG. 1A, the side view show the increased length and width and angle of the nose piece, and the extension of the nosepiece up into the brow area, this maintains space between the user's face and the lens, the extended and widened nose pads prevent movement in a variety of vertical viewing angles.

With reference to FIG. 1B, the bottom of the nose-brow platform that rests on the nose, the angle is wider then other nose pads, this helps the anterior portion of the platform to remain on the forehead, brow area.

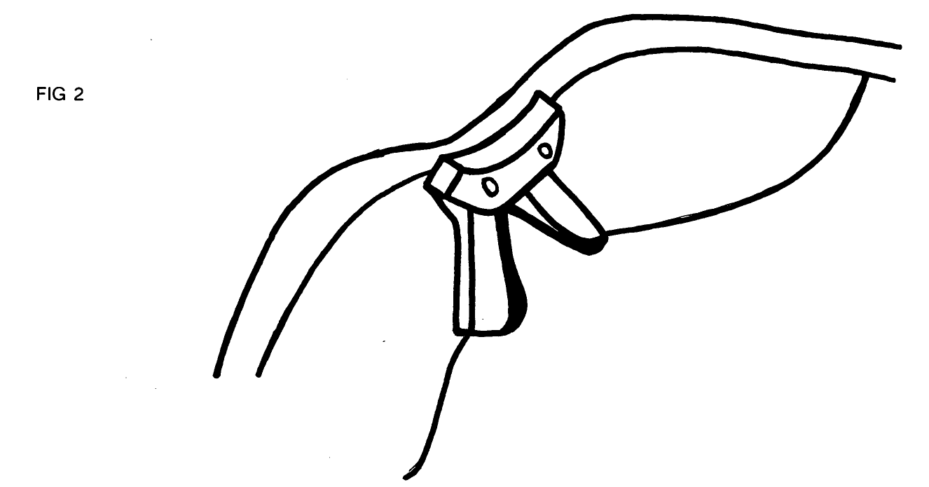

With reference to FIG. 2, show the perspective view of the nose-brow platform on the inside of a pair of safety glasses.

1. An eyewear attachment comprising a nose brow platform defining a cavity therein, the nose brow platform configured to couple to the underside of the rim of the eyewear.

2-10. (canceled)
